(19) United States
(12) Patent Application Publication
(10) Pub. No.: US 2004/0071161 A1
(43) Pub. Date: Apr. 15, 2004

(54) Part maintenance system and part maintenance method of semiconductor processing system

(75) Inventors: Kazushi Tahara, Yamanashi (JP); Akira Obi, Yamanashi (JP)

Correspondence Address: FINNEGAN, HENDERSON, FARABOW, GARRETT & DUNNER, LLP, 1300 I STREET, NW, WASHINGTON, DC, 20005, US

(73) Assignee: Tokyo Electron Limited

(21) Appl. No.: 10/648,341

(22) Filed: Aug. 27, 2003

Related U.S. Application Data
(63) Continuation-in-part of application No. 09/893,628, filed on Jun. 29, 2001, now abandoned.

(30) Foreign Application Priority Data
Jun. 30, 2000 (JP) JP2000-199137

(51) Int. Cl. H04J 3/16; H04J 3/22

(52) U.S. Cl. 370/465

(57) ABSTRACT

A factory-side system having at least one semiconductor processing system, and a vendor-side system owned by an administrator who manages the maintenance of the semiconductor processing system are connected to each other through a bidirectional network. The factory-side system stores a allowable limit value of operation time of a preset part, measures actual operation time of the part, compares the actual operation time and the allowable limit value with each other to judge the operation state of the part, and sends an order processing request of the part to the vendor-side system through the network in accordance with a result of the judgement. If the vendor-side system receives the order processing request of the part, the vendor-side system carries out the order processing of the part. With this, it is possible to prevent trouble, accident and the like of the part.

### FIELD OF THE INVENTION

The present invention relates to a part maintenance system and a part maintenance method of a semiconductor processing system. In this specification, a term ‘part’ is used for specifying a thing that constitutes a part of a semiconductor processing system and is driven by a predetermined part driving device, for instance a gate valve or the like.

### BACKGROUND OF THE INVENTION

It is already well known that in the process of manufacturing the semiconductor device, so many processings and treatments have to be executed, for instance a chemical etching treatment, a thin film formation processing, an ashing treatment, a spattering processing, and so forth. At the same time, a variety of semiconductor processing systems are used in compliance with such processings and treatments. For instance, one example will be seen in a processing system of the multi-chamber type having a so-called cluster tool structure, which enables a plurality of processings and treatments to be executed within a single system. The system of this kind is constructed such that a plurality of vacuum processing and/or treatment chambers are connected with a common transfer chamber, and an objective substrate to be processed and/or treated, for instance a semiconductor wafer, is taken in and taken out from a carry-in and carry-out chamber connected with the vacuum transfer chamber through a preparatory vacuum chamber having a load-lock function. Therefore, the system of this type is suitable for advancing the high integration of the semiconductor device as well as for increasing the high throughput of the same, and also for preventing the objective to be processed and/or treated from various contaminants.

In case of the semiconductor processing system as described above, however, it generally includes a lot of portions moving or to be moved. Therefore, unless they are sufficiently stabilized, its operation speed is made slower and mechanical reliability would be lowered, and it becomes hard for the system to display its full ability and performance adequately. Furthermore, in case the system is once broken down, it cannot help being stopped for a long time for restoration thereof, which would worsen the throughput of the semiconductor device production.

In order to prevent the system from being broken down, the Japanese patent publication No. 2-181299 proposes an automatic breakdown diagnostic system provided with functions of perceiving the usable life of respective portions of the system, selecting portions to be examined, which are likely to fall in the abnormal condition, and checking them. In order to prevent the system from being broken down before its occurrence, to increase the production yield of the semiconductor device being processed, and to maintain a predetermined throughput, the part maintenance in the system comes to be one of the most important things to be done. Speaking of the part maintenance in the system, what has been done so far is at most to check and judge the accumulated operation time and/or the number of operation times of the part and to provide the system with such a maintenance function as automatic issuance of an alarm when the breakdown takes place.

However, in case of the judgment of the part condition relying on the check of the accumulated operation time and the number of operation times, it has not always coincided with presence of the actual abnormal condition in the system. For instance, it actually happens that some parts break down before they reach their prescribed operation time and/or the number of operation times while some others normally work well even exceeding their prescribed operation time and/or the number of operation times. Accordingly, it has been desired to establish not the judgment standard relying only on the accumulated operation time and/or the number of operation times, but the judgment standard much more reasonably meeting the actual part operation.

The present invention has been made in view of such problems as described above, and the object thereof is to provide a part maintenance system and part maintenance method of the semiconductor processing system, by which the abnormal operation of the part can be detected, thereby preventing the system from being broken down well before it occurs.

### SUMMARY OF THE INVENTION

In order to solve the problems as described above, according to the first aspect of the invention, there is provided a part maintenance system of a semiconductor processing system, comprising a factory-side system having at least one semiconductor processing system, and a vendor-side system owned by an administrator who manages the maintenance of the semiconductor processing system, wherein the factory-side system comprises a factory-side sending/receiving means which sends and receives information to and from the vendor-side system through a bidirectional network, a preset means which stores a allowable limit value of operation time or the number of operations of a part of the preset semiconductor processing system, a measuring means which measures actual operation time or the number of actual operations of the part, and a maintenance judging means which compares the actual operation time or the number of actual operations and the allowable limit value with each other to judge an operation state of the part, and which sends an order processing request of the part to the vendor-side system through the network by the factory-side sending/receiving means in accordance with a result of the judgment, the vendor-side system comprises a vendor-side sending/receiving means which sends and receives information to and from the factory-side system through the network, and an order processing means which carries out an order processing of a part when the vendor-side sending/receiving means receives an order processing request of that part from the factory-side system through the network.

To solve the problems as described above, according to the second aspect of the invention, there is provided a part maintenance method in a part maintenance system of a semiconductor processing system in which a factory-side system having at least one semiconductor processing system, and a vendor-side system owned by an administrator who manages the maintenance of the semiconductor processing system are connected to each other through a bidirectional network, the method comprising: a step for presetting a allowable limit value of operation time or the number of operations of the part of the semiconductor processing system by the factory-side system, a step for measuring actual operation time or the number of actual operations of the part by the factory-side system, a step for comparing the actual operation time or the number of actual operations and the allowable limit value with each other by the factory-side system to judge an operation state of the part, and for sending an order processing request of the part to the vendor-side system through the network in accordance with a result of the judgement, and a step for carrying out the order processing of the part when the vendor-side system receives the order processing request of the part from the factory-side system through the network.

According to the first and second aspects of the invention, it is possible to grasp the actual operation state of each part, and, to make a judgement based on this. With this, it is possible to detect abnormality of each part, and to prevent trouble, accident or the like. Further, since it is possible to previously order parts, the parts can be exchanged before it becomes necessary to stop the semiconductor processing system. With this, throughput of the entire semiconductor processing system can be enhanced.

Further, the factory-side system may store at least two stage limit value levels as the allowable limit value which is previously set by the preset means, and when the maintenance judging means judges that the actual operation time or the number of actual operations reaches a first limit value level, the factory-side sending/receiving means may send an order processing request of the part to the vendor-side system through the network, and when the actual operation time or the number of actual operations reaches a next limit value level, the factory-side system may carry out a notice processing.

With this aspect, since it is possible to order parts by the first limit value level, it is possible to order parts before the notice processing such as alarm is carried out by the next limit value level. Therefore, it is possible to prevent trouble and accident. By setting the allowable limit value in a plurality of stages in this manner, it is possible to carry out fine post-processings in accordance with states of parts. Here, the post-processings include various processing in accordance with characteristics of part, such as warning processing, stopping processing of device, acquisition command processing of parts to be exchanged, lifetime estimating processing of part and the like. By such a processing, a user knows abnormal state, and can stop the device to avoid danger and thus or obtain parts to be exchanged beforehand, it is possible to maintain the throughput without stopping the device for a long time.

Further, the vendor-side system may estimate time period required until the level reaches a next limit value level by a part order processing means, and if the vendor-side system judges that the part can be prepared by that time period and a periodic maintenance of the semiconductor processing system is scheduled by that time period, maintenance schedule information for inputting the exchange of the part into a next periodic maintenance schedule may be sent to the factory-side system by the vendor-side sending/receiving means through the network, and if the factory-side sending/receiving means receives the maintenance schedule information, the factory-side system may input the exchange of the part into the next periodic maintenance schedule and renews the periodic maintenance schedule. With this, parts can be exchanged at the time of the next periodic maintenance before the level reaches the next limit value level and thus, it is possible to reduce monitoring load of parts on the factory-side user.

Further, the vendor-side system may estimate time period required until the level reaches the next limit value level by a part order processing means, and if the vendor-side system judges that the part can not be prepared by that time period, the vendor-side system may judge that the maintenance of the part can meet the requirement, and when the vendor-side system judges that the periodic maintenance of the next semiconductor processing system is scheduled by that time period maintenance schedule information for inputting the maintenance of the part into a next periodic maintenance schedule may be sent to the factory-side system by the vendor-side sending/receiving means through the network. With this, even if parts can not be obtained in time, maintenance of parts can meet the requirement instead of exchanging parts.

Further, the operation time or the number of operations of the part which may be stored in the preset means of the factory-side system is a value based on a counted value which is counted by a counter provided in correspondence with the part, the measuring means of the factory-side system may measure the actual operation time or the number of actual operations of the part based on the counted value counted by the counter corresponding to the part. By maintenance judgement of parts is made by the counter in this manner, the structure is simple, the costs is not increased, and the judgement can be made easily.

Further, the measuring means may measure the actual operation time of the part by a counter corresponding to the part as operation time of a part driving means which drives the part.

Further, the preset means of the factory-side system may store normal operation time and its allowable limit value instead of a allowable limit value of the operation time or the number of operations of the part, the measuring means of the factory-side system may measure the actual operation time of the part, the maintenance judging means of the factory-side system may compare the actual operation time of the part and the allowable limit value of the normal operation time of the part with each other to judge the operation state of the part, and the factory-side system may send the order processing request of the part to the vendor-side system through the network by means of the factory-side sending/receiving means in accordance with a result of said judgment.

With this also, it is possible to grasp the actual operation state of each part, and judgement can be made based on this. With this, it is possible to detect abnormality of each part, and to prevent trouble, accident or the like. Especially, assuming that a normal part of the same kind of that of the actually used part is used, the actual operation time of the normal part is compared with the allowable limit value which is previously set as reference, and it is possible to judge the actual operation time of the actual part. With this, it is possible to make a judgement in accordance with presence or absence of abnormality of each the actual part in the maintenance judgement. That is, since a value which becomes a limit value of a normal part is defined as a allowable limit value, it is possible to precisely judge the abnormality of parts of the same kind. Therefore, it is possible to prevent trouble or the like of the part.

Further, the preset means of the factory-side system may store change with the passage of time (referred to as ‘time-passage change’ hereinafter) and its allowable limit value instead of a allowable limit value of the operation time or the number of operations of the part, the measuring means of the factory-side system may measure time-passage change of the actual operation of the part instead of the actual operation time or the number of actual operations of the part, the maintenance judging means of the factory-side system may compare the time-passage change of the actual operation of the part and the allowable limit value of the time-passage change of the normal operation to judge the operation state, and the factory-side system may send the order processing request of the part to the vendor-side system through the network by means of the factory-side sending/receiving means.

With this also, it is possible to detect abnormality of each part, and to prevent trouble, accident or the like. Especially, assuming that a normal part of the same kind as an actually used part is used, a preset allowable limit value is compared with time-passage change of normal operation of this normal part, and it is possible to judge time-passage change of the actual operation of the actual part. With this, it is possible to judge whether each the actual part has abnormality in the maintenance judgement. That is, by defining a limit value of the normal part as a allowable limit value, it is possible to precisely judge the abnormality of the same kind of part also. Therefore, it is possible to prevent trouble or the like of the part.

Further, the factory-side system may include a factory-side server, the factory-side server may include the preset means, the measuring means, the maintenance judging means and the factory-side sending/receiving means, the vendor-side system may include a vendor-side server, the vendor-side server includes the order processing means and the vendor-side sending/receiving means.

Further, the factory-side system may include a factory-side server and a factory-side sending/receiving server, the factory-side server includes the preset means, the measuring means and the maintenance judging means, and the factory-side sending/receiving server may include the factory-side sending/receiving means, the vendor-side system may include a vendor-side server and a vendor-side sending/receiving server, the vendor-side server includes the order processing means, and the vendor-side sending/receiving server may include the vendor-side sending/receiving means.

### BRIEF DESCRIPTION OF THE DRAWINGS

FIG. 1 is a block diagram showing the entire structure of a part maintenance system of a semiconductor processing system according to an embodiment of the present invention.

FIG. 2 is a schematic plan view of one example of the semiconductor processing system of this embodiment.

FIG. 3 is a schematic side view of the semiconductor processing system shown in FIG. 1.

FIG. 4 is a block diagram of a factory-side server and a vendor-side server of this embodiment.

FIG. 5 is a functional block diagram of a maintenance judgment device of this embodiment.

FIG. 6 is a diagram showing one example of a maintenance item database of this embodiment.

FIG. 7 is a diagram showing one example of a configurable value database of this embodiment.

FIG. 8 is a diagram showing one example of a message database of this embodiment.

FIGS. 9A and 9B are flowcharts showing a processing flow of the part maintenance method of this embodiment.

FIG. 10 is a diagram showing one example of an operation screen for inputting predetermined information such as limit value level.

FIG. 11 is a diagram for explaining the limit value level of a gate valve.

FIG. 12 is a diagram of time-passage change of operation of the gate valve.

FIG. 13 is a diagram of time-passage change of operation of gate valve driving means.

FIG. 14 is a block diagram showing an example of another structure of the part maintenance system of the semiconductor processing system according to the embodiment of the present invention.

### DETAILED DESCRIPTION OF THE PREFERRED EMBODIMENTS

In the following, the semiconductor processing system preferably embodied according to the invention will be described in detail with reference to the accompanying drawings. In the following descriptions and the accompanying drawings, like constituents of the invention having almost similar function and structure are designated with like reference numerals and characters, thereby omitting the redundant and repetitive description about such constituents.

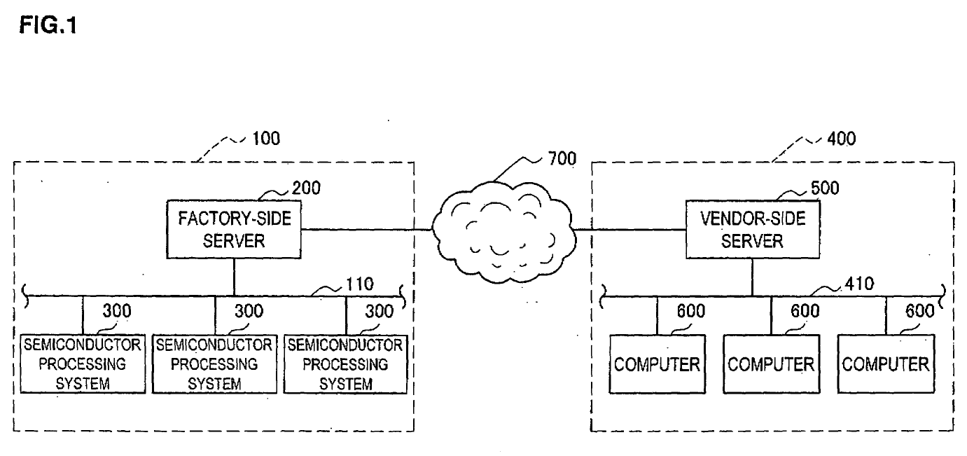

First, a part maintenance system of a semiconductor processing system according to this embodiment of the present invention will be explained with reference to the drawings. FIG. 1 is a block diagram of this system of the embodiment. In this system of the embodiment, a factory-side system 100 provided in a factory which produces semiconductors of a client of the semiconductor processing system, and a vendor-side system 400 owned by a vendor who is an administrator and who orders parts and performs maintenance service such as order parts and maintenance. The factory-side system 100 and the vendor-side system 400 are bidirectionally connected to each other through a network 700 such as the Internet.

The factory-side system 100 includes a factory-side server 200 and a plurality of semiconductor processing systems 300. The factory-side server 200 and the semiconductor processing systems 300 are bidirectionally connected with each other through an internal network 110 such as LAN (Local Area Network). More than one factory-side systems 100 may exist. Kinds and the number of semiconductor processing systems owned by the factory-side system 100 may vary. For example, this semiconductor processing system may be a device for carrying out various processings such as etching, film forming processing, ashing and sputtering. The semiconductor processing system may be a multiple chamber type cluster producing device capable of carrying out a plurality of processing in one device. The factory-side server 200 may be connected to the network 700 (such as the Internet) through a provider (not shown). A computer constituting the factory-side server 200 may have a server function, and may be connected to the network 700, e.g., the Internet. Detailed structure of such a factory-side server will be described later in detail.

The vendor-side system 400 includes a vendor-side server 500 and a plurality of computers 600. The vendor-side server 500 and the computers 600 are mutually connected through an internal network such as LAN. The computers 600 may be disposed in sections of the vendor or offices, but should not be limited. The vendor-side server 500 is bidirectionally connected to the network 700 such as the Internet. Details of such a vendor-side server 500 will be described later.

The network 700 bidirectionally connects the factory-side server 200 and the vendor-side server 500, and is typically a dialup line, but includes closed network such as WAN (Wide Area Network), LAN (Local Area Network), IP-VPN (Internet Protocol-Virtual Private Network). A connection medium is not limited to radio or wired medium, and includes satellite network such as optical fiber cable using FDDI (Fiber Distributed Data Interface), coaxial cable or twist pair cable using Ethernet, radio medium using IEEE802. 11b.

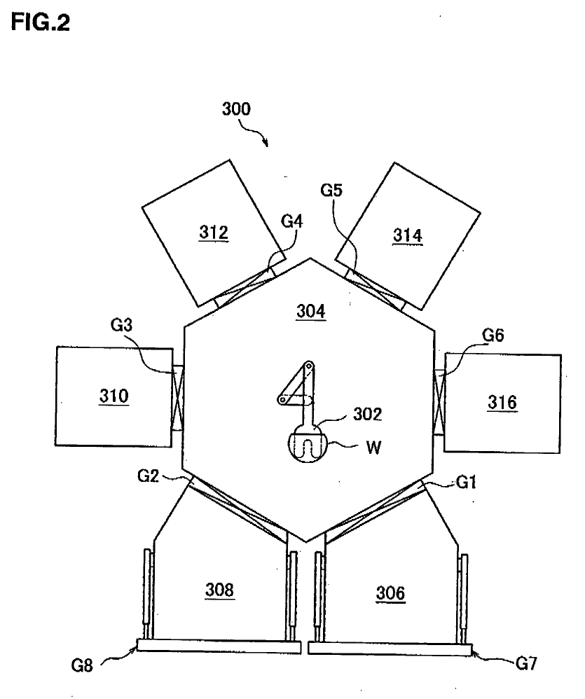

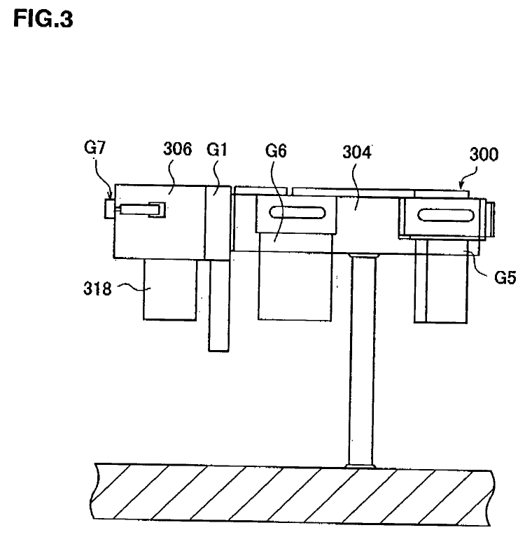

Here, a structure of the semiconductor processing system 300 in the factory-side system 100 will be explained with reference to the drawings. In this embodiment, the semiconductor processing system 300 is a multi-chamber type processing system. FIGS. 2 and 3 are schematic plan view and schematic side view of the semiconductor processing system 300. To start with, the whole structure of this semiconductor processing system 300 will be described with reference to FIGS. 2 and 3. The semiconductor processing system 300 is made up of a vacuum transfer chamber 304 having a transfer arm 302 for transferring an objective to be treated, for instance a semiconductor wafer W, the first through sixth gate valves G1˜G6, the first and second load-lock chambers 306 and 308, and the first through fourth vacuum treatment chambers 310, 312, 314 and 316 for applying predetermined various treatments to the objective semiconductor wafer W, two load-lock chambers 306, 308 and four vacuum treatment chambers 310, 312, 314 and 316 being arranged around the vacuum transfer chamber 304 through one of six gate valves G1˜G6, respectively.

The first and second load-lock chambers 306, 308 carry in and out the semiconductor wafer W between the vacuum transfer chamber 304 and the outside thereof under the atmospheric pressure, keeping the pressure reduced atmosphere inside the vacuum transfer chamber 304 unchanged as far as possible. The inside pressure of the first and second load-lock chambers 306, 308 can be properly controlled and set by means of a pressure regulation mechanism 318 which is made up of a vacuum pump and a gas supply system and installed respectively under the load-lock chambers 306, 308. Each opening of the first and second load-lock chambers 306, 308 formed on the atmospheric pressure side is openably shut with airtightness by means of the seventh and eighth gate valves G7 and G8. The opening and shutting operation of the first through eighth gate valves G1˜G8 is carried out by a driving mechanism (not shown) which drives a valve body forming the essential part of each gate valve to move it up and down. FIG. 3 is a diagram indicating such a state that the first through fourth vacuum treatment chambers 310, 312, 314 and 316 have been disconnected from the semiconductor processing system 300.

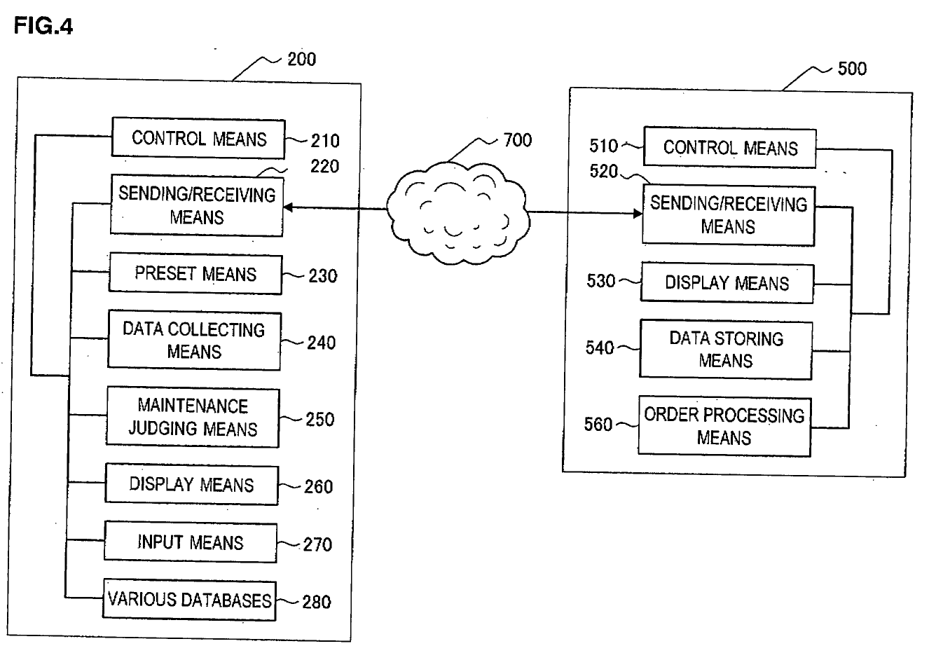

Next, structures of the factory-side server 200 and the vendor-side server 500 will be explained with reference to the drawings. FIG. 4 is a block diagram showing a function structure of the factory-side server 200 and the vendor-side server 500. Here, a factory-side server 200 in one factory-side system 100 of one or more factory-side systems 100 is shown.

As shown in FIG. 4, the factory-side server 200 includes a control means 210, a sending/receiving means (factory-side sending/receiving means) 220, a preset means 230, a data collecting means 240, a maintenance judging means 250, a display means 260, an input means 270, and various databases 280.

The control means 210 controls various sections and manages the information, and carries out processing based on a judgement result of the maintenance judging means 250, instructs retrieval using the various databases 280, and controls signal such as part information. The control means 210 may comprise a CPU (Central Processing Unit) constituting a control means body, a RAM (Random Access Memory), a ROM (read-only memory) and the like.

The sending/receiving means 220 sends and receives various information through the vendor-side server 500 and the network 700. The sending/receiving means 220 sends and receives data using protocol having five or more session layers such as HTTP (Hyhper Text Transfer Protocol), FTP (File Transfer Protocol), SMTP (Simple Mail Transfer Protocol), POP (Post Office Protocol Version 3) or the like. The sending/receiving means 220 may include a fire wall function so as to prevent unauthorized data from entering the factory-side system 100 from the network 700. It is not always necessary to provide the sending/receiving means 220 in the factory-side server 200, and may comprise single hardware which is independent from the factory-side server 200. The sending/receiving means 220 may comprise a plurality of hardware.

The display means 260 comprises a display. Various information including operation screen is displayed on the display means 260. The input means 270 comprises a keyboard, a mouse such as a pointer device. Input operation on the operation screen is carried out through the input means 270.

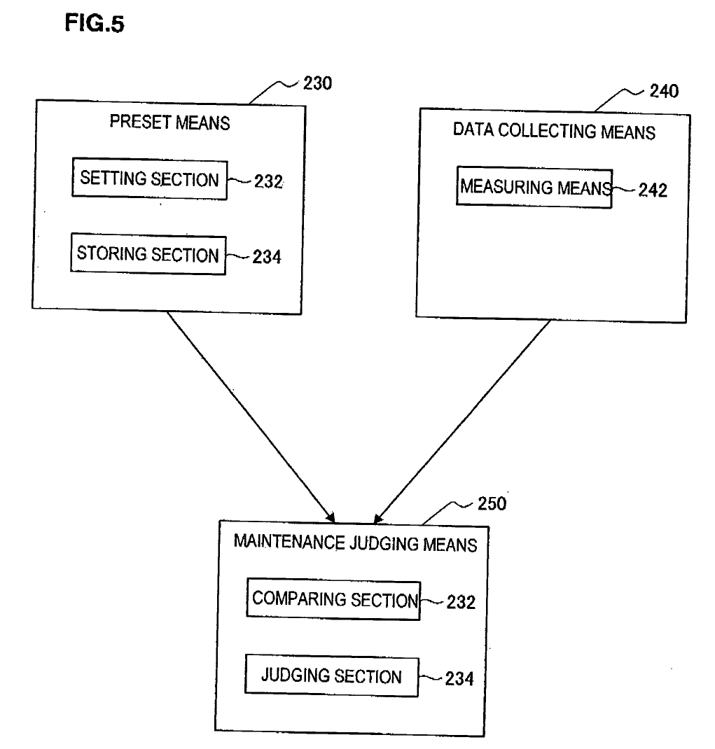

The preset means 230, the data collecting means 240 and the maintenance judging means 250 constitute a part maintenance system shown in FIG. 5 of the semiconductor processing system. FIG. 5 is a function block diagram of the part maintenance system.

The data collecting means 240 has a measuring means 242. The measuring means 242 measures time-passage change of a normal operation of a part. The measuring means 242 may measure the operation of the part itself or may measure the operation of the part driving means. An example of the measuring means 242 is a counter. A plurality of counters are provided in correspondence with parts. The counter may provided in the semiconductor processing system 300. In this case, information of a count value of the counter or of a value (time or number) based on the count value is received from the semiconductor processing system 300.

Type of the counter will be explained. In this explanation, it is assumed that the semiconductor processing system 300 includes an etching device which applies high frequency (RF), electric power to an electrode to bring the processing gas into a plasma state, thereby etching a semiconductor wafer, and a wafer proving device (PM) which is connected to a semiconductor tester to carry out an energization test of an electric circuit formed on a wafer, thereby screening the products.

Examples of the counters provided in the semiconductor processing system 300 are as follows:

(1) RF discharging time counter

(2) cumulative RF discharging time counter

(3) PM usage-frequency counter

(4) cumulative PM usage-frequency counter

(5) operation time counter

(6) driving frequency counter

(7) gas using amount counter

The RF discharging time counter (1) and the cumulative RF discharging time counter (2) count discharging time of high frequency (RF) which is applied to an electrode when the etching device is actually used. The RF discharging time counter (1) counts the RP discharging time for each lot of wafers or each wafer, and the cumulative RF discharging time counter (2) counts the cumulative time of the RF discharging time in the actual processing. The RF discharging time counter (1) can be used for managing parts such as chamber cleaning, exchange of upper electrode, exchange of focus ring, RF generator, baffle plate, matcher and the like.

The PM usage-frequency counter (3) and the cumulative PM usage-frequency counter (4) count the frequency of usage when the wafer proving device is actually used. The PM usage-frequency counter (3) counts the frequency of usage for each lot of wafers or each wafer, and the cumulative PM usage-frequency counter (4) counts the cumulative time of the frequency of usage in the actual processing. The PM usage-frequency counter (3) can be used for managing parts such as chamber cleaning, exchange of upper electrode, exchange of focus ring, RF generator, baffle plate, matcher and the like. The RP discharging time counter (1) and the PM usage-frequency counter (3) may be selected for managing the parts.

The operation time counter (5) counts the operation time when the etching device or the like is actually operated. The driving frequency counter (6) counts the number of driving when the etching device or the like is actually operated. The operation time counter (5) can be used for managing parts such as various batteries, magnet, chiller, vacuum cooling by chiller, magnet cap and the like. The driving frequency counter (6) can be used for managing parts such as shutter open of gate valve, shutter close, various voltage systems., matcher and the like.

The gas using amount counter (7) counts the using amount of gas used when the etching or the like is actually operated. The gas using amount counter (7) can be used for managing parts which depend on a using amount of processing gas.

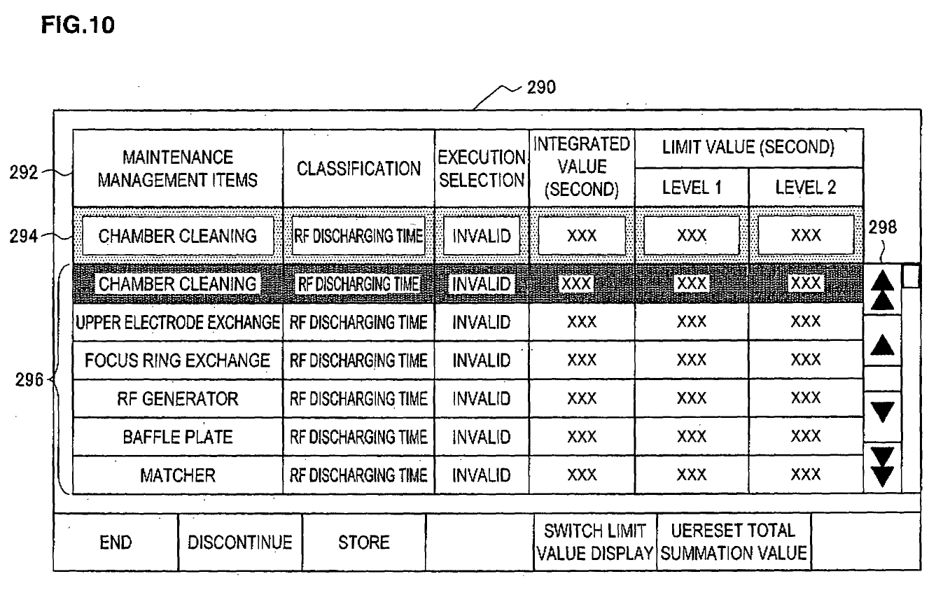

In each of the counters, it is possible to set selection of two kinds of allowable limit values (e.g., limit value levels 1, 2), and “effective” and “ineffective” by means of the operation screen (e.g., FIG. 10). Processings based on the counters may be different in accordance with the setting. The types of the counters are not limited to those described here. As the processing carried out in association with “effective” and “ineffective”, it is considered that alarming processing such as alarm is carried out at the time of “effective”, for example, and alarming processing such as alarm is not carried out at the time of “ineffective”.

The preset means 230 includes a setting section 232 which previously set a allowable limit value of parts (e.g., limit value levels 1, 2), or normal operation time of parts and allowable limit value thereof, time-passage change of normal operation of parts and allowable limit value thereof. The preset means 230 also includes a storing section 234′ which stores set the respective values.

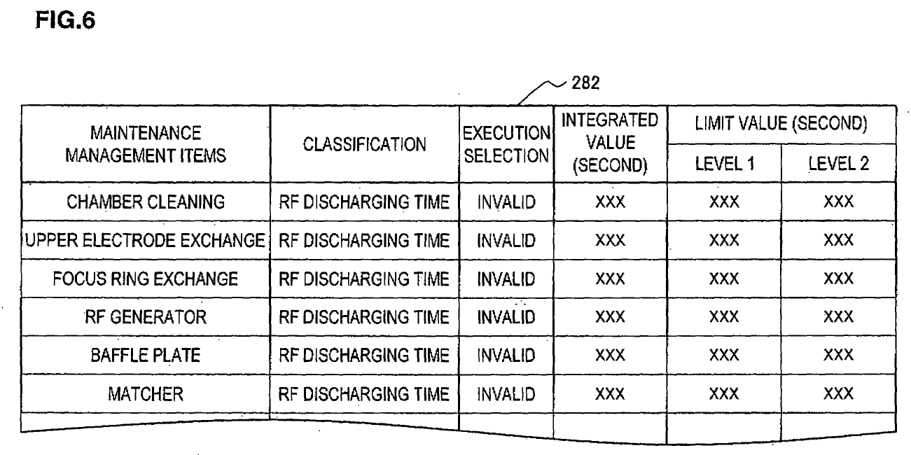

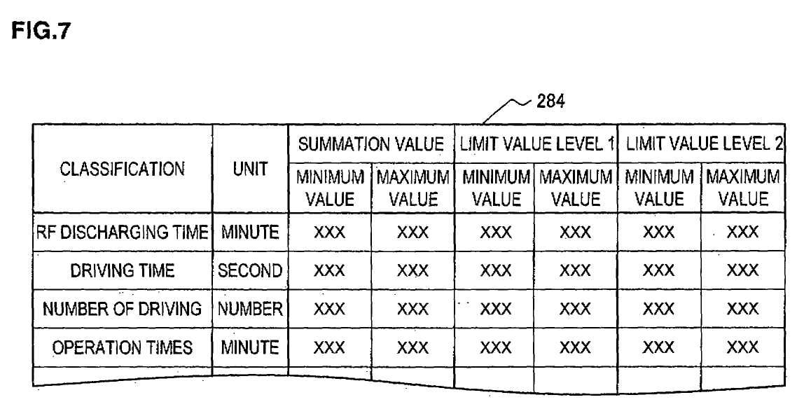

The storing section 234 of the preset means 230 includes a maintenance item database 282 as shown in FIG. 6 for example, and a configurable value database 284 as shown in FIG. 7.

The maintenance item database 282 stores, in association, the counters which manage maintenance of parts and the allowable limit values by the counters for each of the maintenance managing items of the parts. More specifically, as shown in FIG. 6, the maintenance item database 282 includes items of the maintenance managing items of parts, classification showing that value obtained by which counter is used, selection of “effective” and “ineffective”, integrated value by the cumulative PM discharging counter, set allowable limit value (e.g., limit value levels 1, 2). The maintenance item database 282 may be provided for each of the semiconductor processing systems 300. In FIG. 6, the semiconductor processing system 300 can be applied to an etching device for example. The maintenance item database 282 shown in FIG. 6 stores data which is input by the operation screen as shown in FIG. 10 for example.

The configurable value database 284 stores classifications of the counters corresponding to the items of the classification shown in FIG. 6 and the configurable values (minimum value, maximum value) of the allowable limit values (e.g., limit value levels 1, 2) in association. More specifically, as shown in FIG. 7, the configurable value database 284 includes items of classifications of the counters, means, minimum value and maximum value of summation values, and minimum value and maximum value of allowable limit value (e.g., limit value levels 1, 2). The configurable value database 284 may be provided in each of the semiconductor processing systems 300. FIG. 7 can be applied to the semiconductor processing system 300, e.g., an etching device.

The setting section 232 of the preset means 230 indicates an operation screen 290 shown in FIG. 10 on the display section, and sets the allowable limit value of parts by inputting processing by means of the input means 270.

Items 292 in the operation screen 290 shown in FIG. 10 correspond to the items in the maintenance item database 282 shown in FIG. 6. The items 292 can be divided into data input line 294 shown on the top, and data display lines 296 below the data input line 294. Subsequent pages are displayed in the data display lines 296 if a scroll button 298 is pushed.

Data is input in the following manner. If a cursor is placed on a line of the data display lines 296 where the user desires to input, this line is highlighted so that data can be input the data input line 294. In FIG. 10, a line of the chamber cleaning is highlighted as the maintenance management item, and data of this line is displayed in the data input line 294. By this data input line, execution and selection are brought into effective or ineffective, and limit value levels 1, 2 are input. The limit value levels 1, 2 can be set in each part (maintenance management item). At that time, the limit value levels 1, 2 can be set only within a range of minimum value and maximum value of the limit value levels 1, 2 shown in FIG. 7. If a “save” button is pushed below on the operation screen 290 , the input data is stored in the maintenance item database 282. In the operation screen 290, an “exit” button for completing the setting, a “cancel” button for canceling the setting and the like are provided in addition to the above-described buttons.

The maintenance judging means 250 includes a comparison section 252 for comparing a predetermined value by a counter at the time of actual operation of each part (time or the number) with allowable limit value (e.g., limit value levels 1, 2) of the part. The maintenance judging means 250 also includes a judging section 254 for judging the operation state of the part from a result of the comparison from the comparison section 252.

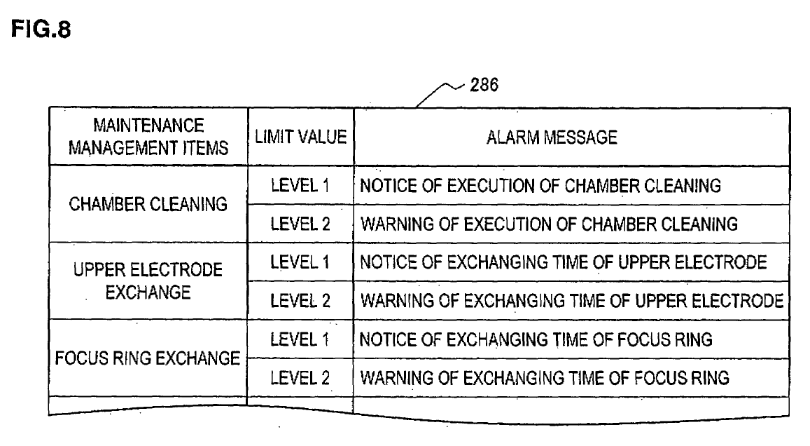

As the various databases 280, there is provided with a message database 286 as shown in FIG. 8. The message database 286 stores alarm message displayed in the display means 260 for each allowable limit value (e.g., limit value levels 1, 2) in association. More specifically, the message database 286 stores an alarm message which is displayed in the display means 260 when it reaches maintenance management items corresponding to the maintenance managing items shown in FIG. 7 and each allowable limit value (e.g., limit value levels 1, 2) in association. For example, in the chamber cleaning which is the maintenance managing item of the part, when the RF discharging time counter is at a limit value level 1, a chamber cleaning execution notice massage is displayed on the display means 260, and when the. RF discharging time counter is at a limit value level 2, a chamber cleaning execution warning massage is displayed on the display means 260.

As the various databases 280, in addition to those described above, there is provided a periodical maintenance database which stores periodic maintenance schedule of each semiconductor processing system 300.

As shown in FIG. 4, the vendor-side server 500 includes a control means 510, a sending/receiving means (vendor-side sending/receiving means) 520, a display means 530 and a data storing means 540. The control means 510 controls various sections, orders parts based on information received from the factory-side server 200, sets the periodic maintenance schedule, and controls the sending operation of the information to the factory-side server 200. The control means 510 may comprises, for example, a CPU constituting the control means body, a RAM, a ROM and the like.

The sending/receiving means 520 sends and receives various information to and from the factory-side server 200 through the network 700. The sending/receiving means 520 sends and receives data using a protocol having five or more session layers such as HTTP, FTP, SMTP, POP and the like corresponding to the factory-side sending/receiving means 220. The sending/receiving means 520 may be provided with a firewall function so as to prevent unauthorized data from entering the vendor-side system 400 from the network 700. It is not always necessary to provide the sending/receiving means 520 in the vendor-side server 500, and may comprise single hardware which is independent from the vendor-side server 500. The sending/receiving means 520 may comprise a plurality of hardware.

The display means 530 comprises a display for displaying various information. The data storing means 540 stores various information necessary for maintenance management of parts. The data storing means 540 stores a periodic maintenance schedule of each semiconductor processing system 300 for example.

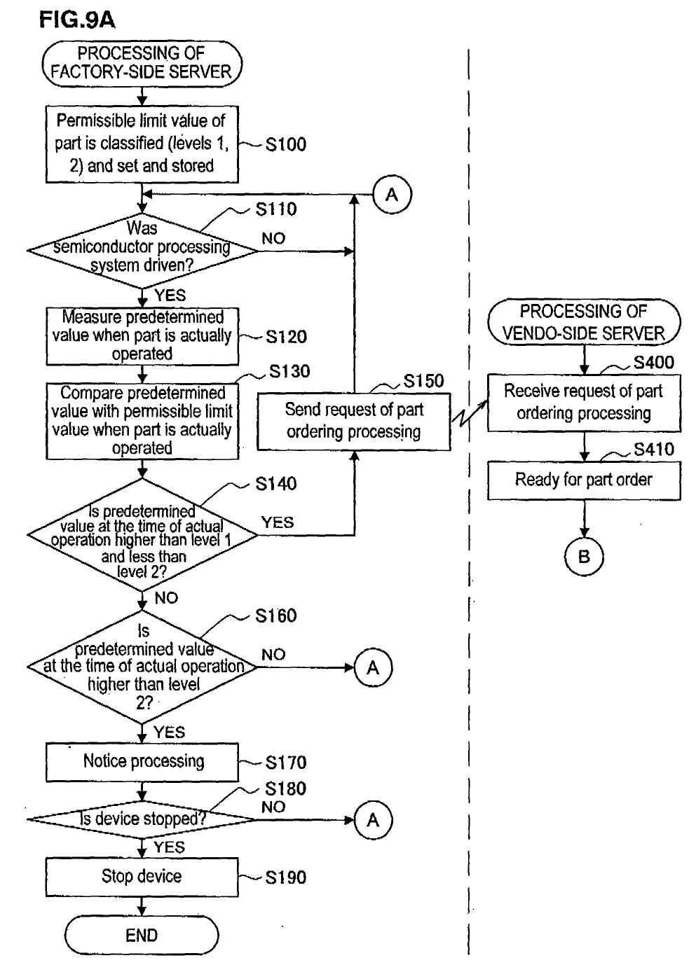

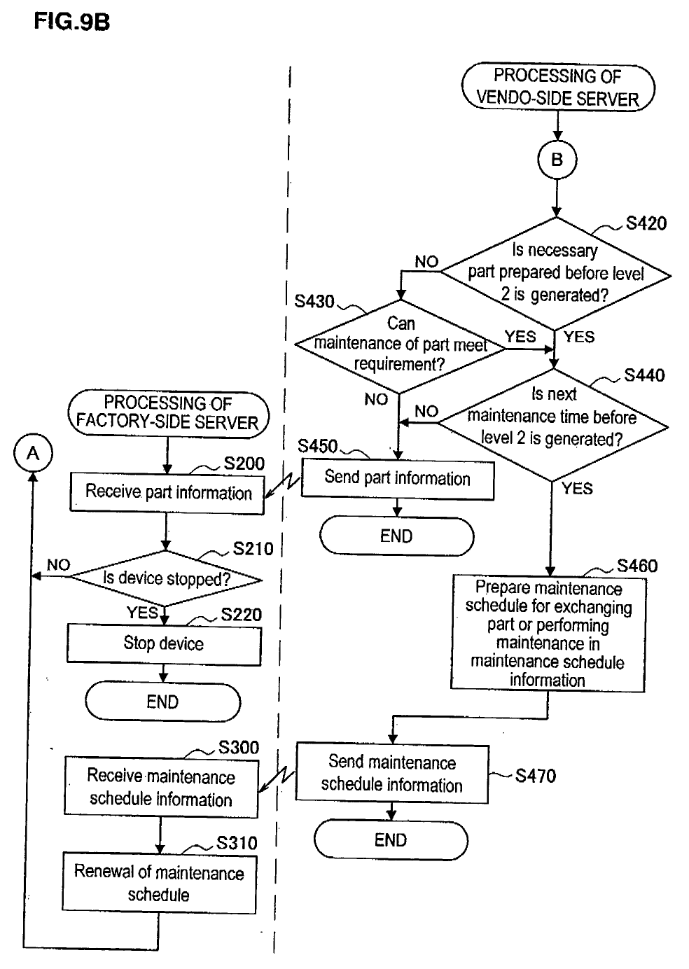

Next, a part maintenance method using the part maintenance system of the semiconductor processing system will be explained. FIGS. 9A and 9B are flowcharts showing flow of processing of the part maintenance method according to this embodiment. The part maintenance method compares a predetermined amount of parts at the time of actual operation with a allowable limit value at the time of normal operation for each part, and judges the operation state of the part, and orders parts and performs the maintenance. Here, as one example, a case in which the actual operation time and a allowable limit value at the normal operation time of a part are compared to judge the operation state of the part will be explained.

The part maintenance processing of this embodiment is divided into processing of the factory-side server 200 and processing of the vendor-side server 500. As shown in FIG. 9A, the allowable limit values of parts of in step S100 are divided into stages and set and stored. Here, the allowable limit values are predetermined values (e.g., times, number and the like) in two stages of limit value levels 1, 2 by a counter as shown in FIG. 6.

More specifically, in each allowable limit value, data which is input based on the operation screen as shown in FIG. 10 displayed by the display section is set in the maintenance item database 282 shown in FIG. 6 and is stored.

Next, the factory-side server 200 judges whether the semiconductor processing system 300 was driven in step S110. If it is judged that the semiconductor processing system 300 was driven, a predetermined value by the counter at the time of actual operation of part is measured for each part in step S120. More specifically, time and number by counters corresponding to the above described maintenance items of parts are measured.

Then, in step S130, the factory-side server 200 compares the predetermined value (time, number or the like) by the counter at the time of actual operation of parts with the allowable limit value (limit value levels 1, 2) for each part, and in step. S140, the factory-side server 200 judges whether the predetermined value (time or number by the counter for example) at the time of actual operation is in a range of limit value level 1 or greater and smaller than limit value level 2. In step S140, if it is judged that the predetermined value (time or number by the counter for example) at the time of actual operation is in the range of limit value level 1 or greater and smaller than limit value level 2, a part ordering processing request is, sent to the vendor-side server 500 through the network 700 in step S150, and the procedure is returned to processing of step S110. If it is judged that the predetermined value at the time of actual operation is in the range of limit value level 1 or greater and smaller than limit value level 2 in step S140, a notice processing may be carried out. For example, an alarm may be given, a massage stored in the limit value level 1 of a corresponding part may be displayed on the display means 260 based on the message database 286.

If it is judged that the predetermined value at the time of actual operation is normal operation time in the range of limit value level 1 or greater and smaller than limit value level 2 in step S140, it is judged whether the predetermined value at the time of actual operation is limit value level 2 or greater in step S160. If it is judged that the predetermined value at the time of actual operation is not greater and smaller than limit value level 2 in step S140, the procedure is returned to processing of step S110. If it is judged that the predetermined value at the time of actual operation is greater and smaller than limit value level 2 in step S140, the notice processing is carried out in step S170. As the notice processing, an alarm is given, a message stored in the limit value level 2 of the corresponding part is displayed on the display means 260 based on the message database 286.

Next, it is judged whether the semiconductor processing system 300 is stopped in step S180. For example, a question as to whether the semiconductor processing system 300 is stopped is displayed on the display means 260, and if operation indicative “No” (procedure should be proceeded) is carried out from the input means 270, it is judged that the semiconductor processing system 300 should not be stopped, and if operation indicative “Yes” (procedure should be stopped) is carried out from the input means 270, it is judged that the semiconductor processing system 300 should be stopped.

If it is judged that the semiconductor processing system 300 should not be stopped in step S180, the procedure is returned to step S110, and if it is judged that the semiconductor processing system 300 should be stopped, the semiconductor processing system 300 is stopped in step S19, and the series part maintenance processing is completed.

On the other hand, if the vendor-side server 500 receives the part ordering processing request from the factory-side server 200 through the network in step S400 as shown in FIG. 9A, the part ordering preparation is carried out in step S410. For example, parts order is sent to a part center through the network 700, and part information such as distribution information, inventory information and the like is received.

Next, as shown in FIG. 9B, the vendor-side server 500 judges whether necessary parts (parts to be exchanged) can be prepared before the maintenance level 2 is generated in step S420 based on the received part information. More specifically, date when the limit value level 2 is generated is estimated based on the current time or number by the counter corresponding to the maintenance of the parts, and it is judged that whether the necessary parts can be prepared by that date.

If it is judged that the necessary parts (parts to be exchanged) can not be prepared before the maintenance level 2 is generated in step S420, it is judged that maintenance of the parts can meet the requirement in step S430. Since parts which can meet the requirement by the maintenance need not always be exchanged, processing in step S430 is effective in such a case.

In step S430, if it is judged that the maintenance of the parts can not meet the requirement, since the parts can not be prepared in time and the maintenance can not meet the requirement, the part information to that effect is sent to the factory-side server 200 through the network 700 in step S450, and the series of part maintenance processing is completed. If the factory-side server 200 receives the part information in step S200, it is judged whether the semiconductor processing system 300 is stopped in step S210 like the step S180. If it is judged that the semiconductor processing system 300 should not be stopped in step S210, the procedure is returned to step S110, and if it is judged that the semiconductor processing system 300 should be stopped, the semiconductor processing system 300 is stopped in step S220 like the step S190, and the series of part maintenance processing is completed.

On the other hand, if it is judged that the necessary parts (parts to be exchanged) can be prepared before the maintenance level 2 is generated in step S420, and when it is judged that the maintenance of the parts can meet the requirement in step S430, it is judged whether the next periodic maintenance is before the limit value level 2 is generated in step S440. More specifically, date when the limit value level 2 is generated is estimated based on the current time or number by the counter corresponding to the maintenance of the parts, and it is judged whether the next periodic maintenance is before that date. The next periodic maintenance time is obtained based on the periodic maintenance schedule stored in the data storing means 540 for example.

If it is judged that the next periodic maintenance time is not before the limit value level 2 is generated in step S440, since the parts can not be exchanged or maintenance can not be performed before the next periodic maintenance, the part information to that effect is sent to the factory-side server 200 through the network 700 in step S450, and the series of part maintenance processing is completed.

If it is judged that the next periodic maintenance time is before the limit value level 2 is generated in step S440, a maintenance schedule information for inputting the part exchange or maintenance into the periodic maintenance schedule is prepared in step S460, the maintenance schedule information is sent to the factory-side server 200 in step S470, and the series of part maintenance processing is completed. If the factory-side server 200 receives the maintenance schedule information from the vendor-side server 500 in step S300, the factory-side server 200 renews the periodic maintenance schedule in the periodic maintenance database stored in the various databases. 280 in step S310. That is, the part exchange or maintenance is incorporated in the next periodic maintenance in the periodic maintenance schedule, and the procedure is returned to the step S110. With this operation, when the next maintenance is performed, the part is exchanged or maintenance is performed.

The processings in steps S400 to S470 are carried out by an order processing means 560 provided in the vendor-side server 500.

As explained above, the factory-side server 200 stores the allowable limit value (e.g., limit value levels 1, 2) of the preset operation time of the number of operations of the semiconductor processing system 300, measures the actual operation time of the number of actual operations of the parts, compares the actual operation time or the number of actual operations with the allowable limit value, thereby judging the operation state of the part, and the sending/receiving means 220 sends the order processing request of the part to the vendor-side server 500 through the network 700 in accordance with a result of the judgement, and if the sending/receiving means 520 receives the ordering processing request of parts from the factory-side server 200, the vendor-side server 300 carries out the ordering processing of the parts. With this operation, it is possible to grasp the actual operation state of each part, and it is possible to make the judgement based on the operation state. With this, it is possible to detect the abnormal state of each part, and to prevent trouble and accident. Further, since it is possible to previously order parts, parts can be exchanged before it becomes necessary to stop the semiconductor processing system. With this, it is possible to enhance the throughput of the entire semiconductor processing system.

The factory-side server 200 stores at least limit value levels 1, 2 of two stages as allowable limit values which are set by the preset means 230, and when the actual operation time or number of actual operations reaches the first limit value level 1 by the maintenance judging means 250, the order processing request of parts is sent to the vendor-side server 500 through the network 700, and when the actual operation time or the number of actual operations reaches the next limit value level 2, the notice processing is carried out.

Since it is possible to send the parts order by the first limit value level 1, it is possible to send the parts order before the notice processing such as the alarm is carried out by the next limit value level 2, it is possible to prevent the trouble, accident or the like. By setting the allowable limit values in a plurality of stages in this manner, it is possible to carry out extremely fine post-processings in accordance with states of parts. Here, the post-processings include various processing in accordance with characteristics of part, such as warning processing, stopping processing of device, acquisition command processing of parts to be exchanged, lifetime estimating processing of part and the like. By such a processing, a user knows abnormal state, and can stop the device to avoid danger and thus, it is possible to maintain the throughput without stopping the device for a tong time.

The vendor-side server 500 estimates the time period elapsed until the level reaches the next limit value level 2, and if it is judged that the parts can be prepared by that time period and the, next periodic maintenance of the semiconductor processing system is scheduled by that time period, maintenance schedule information for inputting the exchange of the parts into the next periodic maintenance schedule is sent to the factory-side server 200 by the sending/receiving means 520 through the network 700, and if the sending/receiving means 220 receives the maintenance schedule information, the factory-side server 200 input the parts exchange into the maintenance schedule and renews the periodic maintenance schedule. With this, since the parts can be exchanged at the time of the next periodic maintenance before the level reaches the next limit value level 2, it is possible to reduce the load for the factory-side users of monitoring parts.

The vendor-side server 500 estimates time period elapsed until the level reaches the next limit value level 2, and if parts can not be prepared until that time period, it is judged that the maintenance of parts can meet the requirement, and when it is judged that the next periodic maintenance of the semiconductor processing system is scheduled by that time period, maintenance schedule information for inputting the maintenance of the parts into the next periodic maintenance schedule is sent to the factory-side server 200 by the sending/receiving means 520 through the network 700. With. this, even if the parts can not be prepared in time, the maintenance can meet the requirement instead of exchanging parts.

Next, another example of a allowable limit value in maintenance judgement of parts (steps S130 to S160) will be explained. Here, assumed normal operation time of a normal part is defined as a reference, and the allowable limit value is time measured from this reference value. The number of stages of the allowable limit value is three.

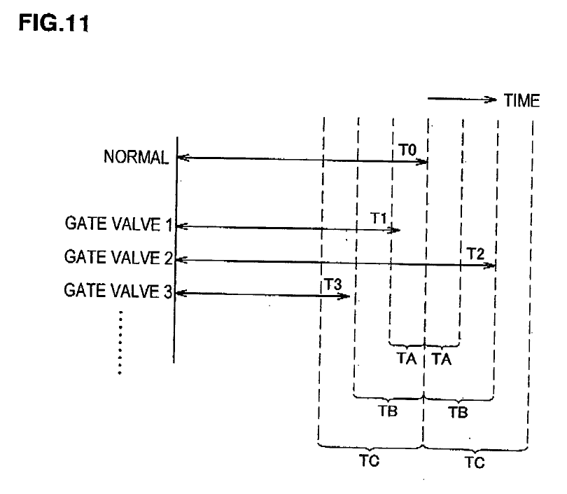

Using such allowable limit value, a concrete example in which the allowable limit value is applied to a gate valve which is an actual part will be explained. FIG. 11 is a diagram for explaining time-passage change of operation of the gate valve. The normal operation time and the actual operation time of the gate valve are obtained using driving time by a driving time counter.

First, assuming that a normal gate valve is used, normal operation time T0 and three stage allowable limit values (limit value levels 1, 2, 3) are set and stored (step S100). For example, a limit value level 1 in step S140 is defined as T0±TA, a limit value level 2 in step S160 is defined as T0±TB, and a limit value level 3 is defined as T0±TC. Here, TA<TB<TC.

Next, the semiconductor processing system 300 is driven (step S110) and the actual operation time of the gate valve is measured (step S120). For example, the actual operation time of a gate valve 1 is T1. After the operation of the semiconductor processing system 300 is completed, the allowable limit value of the normal operation time of the set gate valve and the measured actual operation time of the gate valve are compared, and maintenance judgement is carried out (steps S130 to S160).

Here, when the actual operation time T is smaller than the limit value level 1 (T0−TA<T<T0+TA), the operation of the semiconductor processing system 300 is continued. On the other hand, when the actual operation time T is in a range of limit value level 1 or greater and smaller than limit value level 2, (T0−TB<T≦T0−TA or T0+TA≦T<T0+TB), the parts ordering processing request is sent to the vendor-side server 500. When the actual operation time T is in a range of limit value level 2 or greater and smaller than limit value level 3 (T0−TC≦T0−TB or T+TB≦T<T0+TC), the notice processing such as alarm is carried out (step S170), and it is judged whether the semiconductor processing system 300 should be stopped. At that time, if the stopping processing of the semiconductor processing system 300 is carried out by the input means 270, the semiconductor processing system 300 is stopped.

As will be seen from FIG. 11, since the actual operation time T1 of the gate valve 1 is in the range of T0−TA<T1<T0+TA, the operation of the semiconductor processing system 300 is continued. In the case of the gate valve 2 shown in FIG. 11, since its actual operation time T2 is in the range of T0+TA<T2<T0+TB, the parts order processing is carried out. In the case of the gate valve 3, since its actual operation time T3 is in the range of T0−TC<T3<T0−TB, the notice processing such as alarm is carried out, the operation of the semiconductor processing system 300 is stopped based on operation by the input means 270 or the like.

In this manner, the abnormal operation of the part can be detected by comparing the actual operation time of the part with the allowable limit value levels corresponding thereto, so that it becomes possible to make a judgment well meeting the more realistic gate valve operation.

Especially, assuming that a normal part of the same kind of that of the actually used part is used, the actual operation time of the normal part is compared with the allowable limit value which is previously set as reference, and it is possible to judge the actual operation time of the actual part. With this, it is possible to make a judgement in accordance with presence or absence of abnormality of each the actual part in the maintenance judgement. That is, since a value which becomes a limit value of a normal part is defined as a allowable limit value, it is possible to precisely judge the abnormality of parts of the same kind.

Furthermore, as the allowable limit value levels corresponding to the normal part operation time is set in the form of a plurality of discrete limit value levels, each gate valve can be properly dealt with according to the corresponding limit value level. This means that the trouble, accident, or the like of the system can be prevented before their occurrence.

The predetermined value at the time of the actual operation may be measured by measuring the actual operation time of the part driving means which drives the part by a counter instead of measuring the operation of the part itself by the counter. For example, it is possible to measure the operation time of a motor which drives the gate valve. There is no difference between effects that are obtained by the above two ways of measurement, that is, the same effect is obtainable.

Next, another example of the allowable limit value in the maintenance judgment of parts (steps S130 to S160) will be explained. Here, time-passage change of operation of an assumed normal part is defined as a reference, and the allowable limit value is defined as a variation amount from this reference value. The number of stages of the allowable limit values is two.

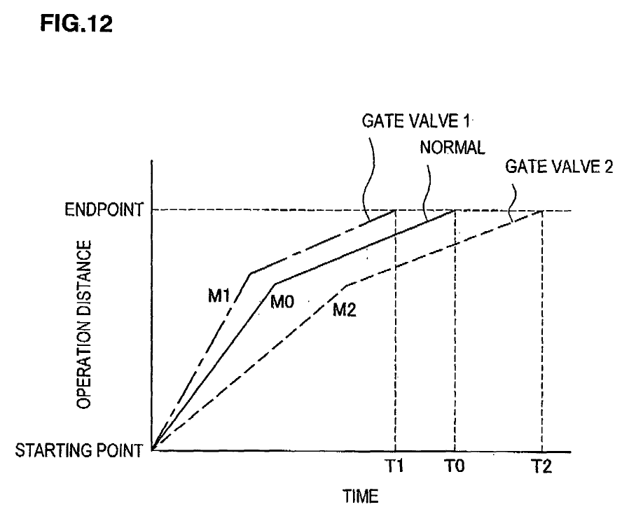

Using such a allowable limit value, a concrete example in which the allowable limit value is applied to a gate valve which is an actual part will be explained. FIG. 12 is a diagram for explaining the other example of limit value level of the gate valve. The time-passage change and actual time-passage change of the normal operation of the gate valve are obtained using driving time by the driving time counter.

FIG. 12 shows a graph of which the abscissa represents the time while the ordinate does the operation distance of the gate valve, and describes the time-passage change of the gate valve operation, more particularly, the open and shut operation of the gate valve operation from its start point to its terminal point. In FIG. 12, a solid line describes the time-passage change of the normal operation by the above supposed normal gate valve while a single dotted chain line and a double dotted chain line describe the time-passage change s of the operation by actual gate valves 1 and 2, respectively. Strictly speaking, these time-passage change s should be drawn with curves, not bent straight lines. However, for just simplification, the graph is drawn by approximating curves with the bent straight lines. The inflexion point (bent point) as will be seen on way of each straight line is naturally born as the result that in order to open and shut the gate valve, the gate valve has to be first lifted in one direction and then moved in the other direction.

Here, let us consider and use the operation speed as a parameter describing the time-passage change of the gate valve operation. The operation speed can be obtained from the inclination of the straight lines of FIG. 12. At first, supposing a normal gate valve, let the inclination of a line in the graph, which extends the start point up to the inflexion point and represents the time-passage change with regard to the normal operation of the gate valve be M0. Furthermore, two stage allowable limit values (limit value levels 1, 2) with respect to M0 are set and stored (step S100). For example, the limit value level 1 is defined as M0±MA, and the limit value level 2 is defined as M0±MB. Here, MA<MB.

In the next, the system is driven (step S110) during which the time-passage change of the actual gate valve operation is measured (step S120). At this time, the inclination of the line from the start point up to the inflexion point is M1, which represents the time-passage change with regard to the actual operation of the gate valve 1. After termination of the system driving, the allowable limit value levels as set with regard to the time-passage change of the normal gate valve operation and the time-passage change with respect to the actual operation of the measured gate valve arc compared with each other, thereby judging the need of the part maintenance from the result of the above comparison (steps S130 to S160).

Here, when the time-passage change M of the actual operation is smaller than the limit value level 1 (M0−MA<M<M0+MA), the operation of the semiconductor processing system 300 is continued. On the other hand, if the time-passage change M of the actual operation is in a range of limit value level 1 or greater and smaller than the limit value level 2 (M0−MA<MI≦M0−MA or M0−MA≦MI<M0+MB), the part ordering processing request is sent to the vendor-side server 500 When the time-passage change M of the actual operation is the limit value level 2 or greater (T≦T0−TB or T+TB≦T), the notice processing such as alarm is carried out (step S170), and it is judged whether the semiconductor processing system 300 should be stopped. At that time, if the operation stopping processing of the semiconductor processing system 300 is carried out by the input means 270, the semiconductor processing system 300 is stopped.

For example, as shown in FIG. 12, if the time-passage change M1 of the actual operation is M0−MA<M1<M0+MA, the operation of the semiconductor processing system 300 is continued. If the inclination M2 of the line extending from the start point to the inflexion point, which describes the time-passage change in respect to the actual operation of the gate valve 2, is in the range of M0−MB<M2<M0−MA, the parts order processing is carried out.

In this manner, the abnormal operation of the part can be detected by comparing the allowable limit value levels of the time-passage change in regard to the normal operation of the part with the time-passage change in regard to the actual operation of the part, so that it becomes possible to make a judgment well meeting the more realistic part operation.

Especially, assuming that a normal part of the same kind as an actually used part is used, a preset allowable limit value is compared with time-passage change of normal operation of this normal part, and it is possible to judge time-passage change of the actual operation of the actual part. With this, it is possible to judge whether each the actual part has abnormality in the maintenance judgement. That is, by defining a limit value of the normal part as a allowable limit value, it is possible to precisely judge the abnormality of the same kind of part also.

Furthermore, as the allowable limit value levels of the time-passage change in regard to the normal operation is discretely set in the form of a plurality of levels, each part can be dealt with by the post-processing properly meeting its level. This means that the trouble, accident, or the like of the system can be prevented before their occurrence.

In the example as described above, the inclination of the line indicating the gate valve movement from the start point to the inflexion point has been considered as that which represents the time-passage change with respect to the normal operation of the gate valve. However, it may be possible to consider the inclination of the line extending from the inflexion point to the terminal point thereof in the same manner. Furthermore, it may be also possible to use the combination of both of the above two inclinations. Still further, the linear approximated operation speed is considered as a parameter indicating the time-passage change of the operation. However, some other parameter may be used. For instance, if the graph of FIG. 12 is drawn with curves, it may be possible to first measure the operation speed at each time point and then to calculate and use the amount of variation obtained from the measured maximum and minimum values.

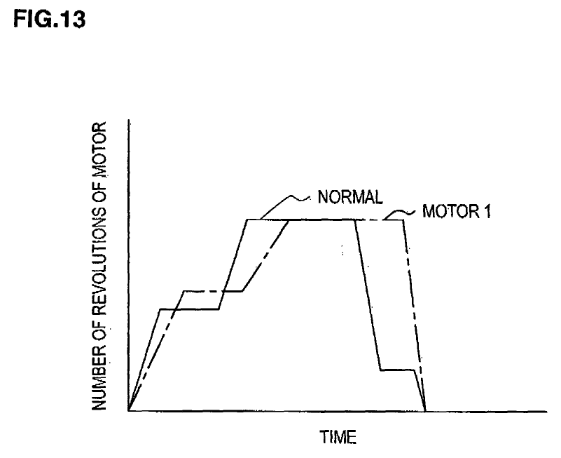

The time-passage change of the actual operation may be measured by measuring the time-passage change of operation of the part driving means instead of measuring the operation of the part itself. For example, it may be possible to measure the time-passage change with regard to the operation of a motor which is a means for driving the gate valve. In FIG. 13, the graph drawn with a solid line represents the time-passage change of the normal operation of a supposed motor while the graph drawn with a single dotted chain line represents time-passage change in respect to the operation of an actual motor. In this case, similar to the cases as described above, the time-passage change of the actual operation is measured and then compared with the allowable limit value levels of the time-passage change of the normal operation, thereby the maintenance judgment being executed with the same effect as that obtained by the other ways described above.

As a part for which maintenance is to be performed is not limited to the above-described gate valve, and the invention is applicable to other parts related to the semiconductor processing system 300.

The judgment method according to the invention making use of the operation time and the time-passage change of the operation can work in combination with such a prior art judgment method as makes use of the accumulated operation time and the number of the times of operations. In such a case, the trouble, accident, or the like of the system would be more effectively prevented before their occurrence.

The invention has been described so far by way of some of preferred embodiments thereof with reference to the accompanying drawings. Needless to say, however, the invention can not be limited by these embodiments. It is apparent that any one who has an ordinary skill in the art is able to make various changes and modifications within the technical thoughts as recited in the scope of claim for patent as per attached hereto, and it is understood that those changes and modifications are covered by the technical scope of the invention, naturally.

For example, the semiconductor processing system is not limited to the multiple chamber type system, and the semiconductor processing system may be an in-line type system or other general semiconductor processing system.

In the above embodiment, the factory-side server provided in the factory-side system 100 includes the preset means 230, the data collecting means 240 (measuring means 242), the maintenance judging means 250 and the factory-side sending/receiving means 220, and the vendor-side server 500 provided in the vendor-side system includes the order processing means 560 and the vendor-side sending/receiving means 520. However, the present invention is not limited to this structure only.

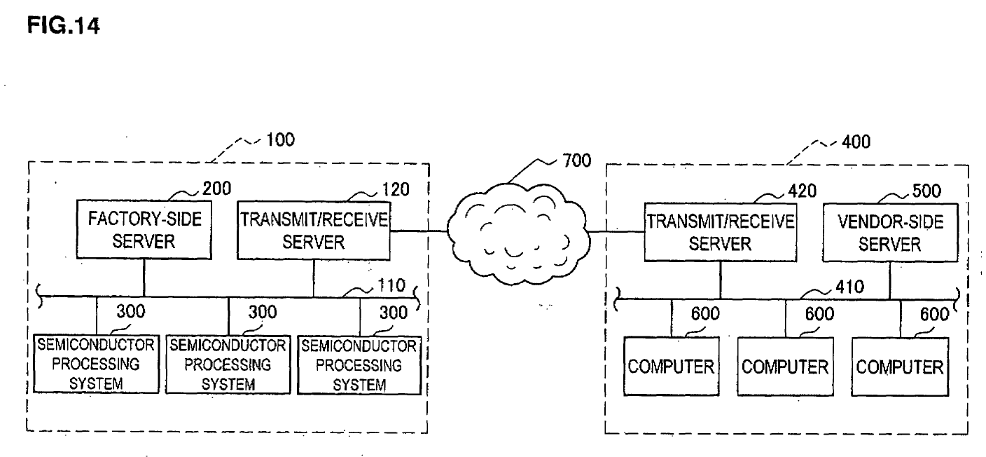

For example, the factory-side system 100 may have a factory-side server 120 connected to an internal network 110 in addition to the factory-side server 200 as shown in FIG. 14, the factory-side sending/receiving means 220 may be provided with the preset means 230, the data collecting means 240 (measuring means 242) and the maintenance judging means 250, and the factory-side server 120 may be provided with the factory-side sending/receiving means 220.

Further, the vendor-side system 400 may have a vendor-side server 420 connected to an internal network 410 in addition to the vendor-side server 500, the vendor-side server 500 may be provided with the order processing means 560, and the vendor-side server 420 may be provided with the vendor-side sending/receiving means 520. By providing the factory-side server 120 and the vendor-side server 420 independently from the factory-side server 200 and the vendor-side server 500 in this manner, load on each server can be reduced.

Each of the sending/receiving servers 120, 420 may be provided with a firewall function so as to prevent unauthorized data from entering the factory-side system 100 and the vendor-side system 400 from the network 700.

The preset means 230, the data collecting means 240 (measuring means 242) and the maintenance judging means 250 provided in the factory-side system 100 may be provided in each semiconductor processing system 300.

According to such a present invention, the abnormal operation of the part can be detected based on the allowable limit value of parts and it becomes possible to make a judgment well meeting the more realistic part operation. Furthermore, as the allowable limit value levels with respect to the time-passage change of the normal operation is discretely set in the form of a plurality of levels, each part can be dealt with by the post-processing properly meeting its level. Accordingly, the trouble, accident, or the like of the semiconductor processing system can be prevented before their occurrence. Further, since it is possible to previously order parts, the part can be exchanged before it becomes necessary to stop the semiconductor processing system. With this, it is possible to enhance the throughput of the entire semiconductor processing system.

What is claimed is:

1. A part maintenance system of a semiconductor processing system, comprising a factory-side system having at least one semiconductor processing system, and a vendor-side system owned by an administrator who manages the maintenance of said semiconductor processing system, wherein
said factory-side system comprises a factory-side sending/receiving means which sends and receives information to and from said vendor-side system through a bidirectional network, a preset means which stores a allowable limit value of operation time or the number of operations of a part of said preset semiconductor processing system, a measuring means which measures actual operation time or the number of actual operations of said part, and a maintenance judging means which compares said actual operation time or the number of actual operations and said allowable limit value with each other to judge an operation state of said part, and which sends an order processing request of said part to said vendor-side system through said network by said factory-side sending/receiving means in accordance with a result of said judgment,
said vendor-side system comprises a vendor-side sending/receiving means which sends and receives information to and from said factory-side system through said network, and an order processing means which carries out an order processing of a part when said vendor-side sending/receiving means receives an order processing request of that part from said factory-side system through said network.

2. A part maintenance system of a semiconductor processing system according to claim 1, wherein
said factory-side system stores at least two stage limit value levels as said allowable limit value which is previously set by said preset means, and when said maintenance judging means judges that said actual operation time or the number of actual operations reaches a first limit value level, said factory-side sending/receiving means sends an order processing request of the part to said vendor-side system through said network, and when said actual operation time or the number of actual operations reaches a next limit value level, said factory-side system carries out a notice processing.

3. A part maintenance system of a semiconductor processing system according to claim 2, wherein
said vendor-side system estimates time period required until the level reaches a next limit value level by a part order processing means, and if said vendor-side system judges that the part can be prepared by that time period and a periodic maintenance of said semiconductor processing system is scheduled by that time period, maintenance schedule information for inputting the exchange of the part into a next periodic maintenance schedule is sent to said factory-side system by said vendor-side sending/receiving means through said network,
if said factory-side sending/receiving means receives the maintenance schedule information, said factory-side system inputs the exchange of the part into the next periodic maintenance schedule and renews said periodic maintenance schedule.

4. A part maintenance system of a semiconductor processing system according to claim 3, wherein
said vendor-side system estimates time period required until the level reaches the next limit value level by a part order processing means, and if the vendor-side system judges that the part can not be prepared by that time period, the vendor-side system judges that the maintenance of the part can meet the requirement, and when the vendor-side system judges that the periodic maintenance of the next semiconductor processing system is scheduled by that time period, maintenance schedule information for inputting the maintenance of the part into a next periodic maintenance schedule is sent to said factory-side system by said vendor-side sending/receiving means through said network.

5. A part maintenance system of a semiconductor processing system according to claim 1, wherein
the operation time or the number of operations of said part which is stored in the preset means of said factory-side system is a value based on a counted value which is counted by a counter provided in correspondence with said part,
said measuring means of said factory-side system measures the actual operation time or the number of actual operations of said part based on the counted value counted by the counter corresponding to said part.

6. A part maintenance system of a semiconductor processing system according to claim 5, wherein
said measuring means measures the actual operation time of said part by a counter corresponding to said part as operation time of a part driving means which drives said part.

7. A part maintenance system of a semiconductor processing system according to claim 1, wherein
the preset means of said factory-side system stores normal operation time and its allowable limit value instead of a allowable limit value of the operation time or the number of operations of said part,
said measuring means of said factory-side system measures the actual operation time of said part,
said maintenance judging means of said factory-side system compares the actual operation time of said part and the allowable limit value of the normal operation time of said part with each other to judge the operation state of said part, and said factory-side system sends the order processing request of said part to said vendor-side system through said network by means of said factory-side sending/receiving means in accordance with a result of said judgment.

8. A part maintenance system of a semiconductor processing system according to claim 1, wherein
the preset means of said factory-side system stores time-passage change and its allowable limit value instead of a allowable limit value of the operation time or the number of operations of said part,
said measuring means of said factory-side system measures time-passage change of the actual operation of said part instead of the actual operation time or the number of actual operations of said part,
said maintenance judging means of said factory-side system compares the time-passage change of the actual operation of said part and the allowable limit value of the time-passage change of the normal operation to judge the operation state, and said factory-side system sends the order processing request of said part to said vendor-side system through said network by means of said factory-side sending/receiving means in accordance with a result of said judgment.

9. A part maintenance system of a semiconductor processing system according to claim 1, wherein
said factory-side system includes a factory-side server, said factory-side server includes said preset means, said measuring means, said maintenance judging means and said factory-side sending/receiving means,
said vendor-side system includes a vendor-side server, said vendor-side server includes said order processing means and said vendor-side sending/receiving means.

10. A part maintenance system of a semiconductor processing system according to claim 1, wherein
said factory-side system includes a factory-side server and a factory-side sending/receiving server, said factory-side server includes said preset means, said measuring means and said maintenance judging means, and said factory-side sending/receiving server includes said factory-side sending/receiving means,
said vendor-side system includes a vendor-side server and a vendor-side sending/receiving server, said vendor-side server includes the order processing means, and said vendor-side sending/receiving server includes said vendor-side sending/receiving means.

11. A part maintenance method in a part maintenance system of a semiconductor processing system in which a factory-side system having at least one semiconductor processing system, and a vendor-side system owned by an administrator who manages the maintenance of said semiconductor processing system are connected to each other through a bidirectional network, said method comprising:
a step for presetting a allowable limit value of operation time or the number of operations of said semiconductor processing system by said factory-side system,
a step for measuring actual operation time or the number of actual operations of said part by said factory-side system,
a step for comparing said actual operation time or the number of actual operations and said allowable limit value with each other by said factory-side system to judge an operation state of said part, and for sending an order processing request of said part to said vendor-side system through said network in accordance with a result of the judgement, and
a step for carrying out the order processing of said part when said vendor-side system receives the order processing request of the part from said factory-side system through said network.

12. A part maintenance method according to claim 11, wherein
said allowable limit value which is previously set by said factory-side system is at least two stage limit value level,
when said factory-side system judges that said actual operation time or the number of actual operations reaches a first limit value level, the order processing request of the part is sent to said vendor-side system through said network, and when said factory-side system judges that the actual operation time or the number of actual operations reaches a next limit value level, a notice processing is carried out.

13. A part maintenance method according to claim 12, wherein
said vendor-side system estimates time period required until the level reaches a next limit value level by a part order processing means, and if said vendor-side system judges that the part can be prepared by that time period and a periodic maintenance of said semiconductor processing system is scheduled by that time period, maintenance schedule information for inputting the exchange of the part into a next periodic maintenance schedule is sent to said factory-side system through said network,
if said factory-side system receives the maintenance schedule information through the network, said factory-side system inputs the exchange of the part into the next periodic maintenance schedule and renews said periodic maintenance schedule.

14. A part maintenance method according to claim 13, wherein
said vendor-side system estimates time period required until the level reaches the next limit value level by a part order processing means, and if the vendor-side system judges that the part can not be prepared by that time period, the vendor-side system judges that the maintenance of the part can meet the requirement, and when the vendor-side system judges that the periodic maintenance of the next semiconductor processing system is scheduled by that tirne period, maintenance schedule information for inputting the maintenance of the part into a next periodic maintenance schedule is sent to said factory-side system through said network.

15. A part maintenance method according to claim 11, wherein
a allowable limit value of operation time or the number of operations of said part which is stored in said factory-side system is a value based on a counted value which is counted by a counter provided in correspondence with said part,
actual operation time or the number of actual operations of said part is measured by said factory-side system based on the counted value of the counter corresponding to said part.

16. A part maintenance method according to claim 15, wherein
the actual operation time of said part is measured by a counter corresponding to said part as operation time of a part driving means which drives said part.

17. A part maintenance method according to claim 11, wherein
said factory-side system stores normal operation time and its allowable limit value instead of a allowable limit value of the operation time or the number of operations of said part,
said factory-side system measures the actual operation time of said part,
said maintenance judging means of said factory-side system compares the actual operation time of said part and the allowable limit value of the normal operation time of said part with each other to judge the operation state of said part, and said factory-side system sends the order processing request of said part to said vendor-side system through said network in accordance with a result of said judgment.

18. A part maintenance method of a semiconductor processing system according to claim 11, wherein
said factory-side system stores time-passage change and its allowable limit value instead of a allowable limit value of the operation time or the number of operations of said part,
said factory-side system measures time-passage change of the actual operation of said part instead of the actual operation time or the number of actual operations of said part,
said factory-side system compares the time-passage change of the actual operation of said part and the allowable limit value of the time-passage change of the normal operation to judge the operation state of said part, and said factory-side system sends the order processing request of said part to said vendor-side system through said network in accordance with a result of said judgment.
